(19) United States
(12) Patent Application Publication
(10) Pub. No.: US 2013/0089119 A1
(43) Pub. Date: Apr. 11, 2013

(54) LASER COMPRISING A LASER MEDIUM

(71) Applicant: Daniel Kopf, Rothis (AT)

(72) Inventor: Daniel Kopf, Rothis (AT)

(73) Assignee: HIGH Q LASER GMBH, Rankweil (AT)

(21) Appl. No.: 13/806,026

(22) PCT Filed: May 10, 2011
(86) PCT No.: PCT/AT11/00219

§ 371 Date: Dec. 20, 2012

(30) Foreign Application Priority Data
Jun. 22, 2010 (AT) A 1031/2010

(51) Int. Cl. H01S 3/091

(52) U.S. Cl. CPC H01S 3/091
USPC 372/69

(57) ABSTRACT

A laser having a standing wave resonator including a first resonator section, which has at least a first end mirror and a second resonator section, which has at least a second end mirror. At least one of the optical elements of the first resonator section is embodied in focusing fashion. Accordingly, the beam axes of the laser beam which arrives upon respective tiltings of at least one of the optical elements in the second resonator section have at least one crossing point, which lies in the pump region of the laser medium or is at a distance from the pump region which amounts to less than the Rayleigh length. The radius (w) of the laser beam is less than five times the radius (w) of the laser beam in the pump region of the laser medium.

### FIELD OF INVENTION

The invention relates to a laser comprising a laser medium, which is excited in a pump region, and a standing wave resonator, which has optical elements, by which a laser beam, which has a beam axis and penetrates the laser medium, is guided and which comprise a first and a second end mirror, wherein the resonator comprises a first resonator section, which has the first end mirror and optionally further of the optical elements, which interact with the laser beam between the first end mirror and the laser medium, and a second resonator section, which has the second end mirror and further of the optical elements, which interact with the laser beam between the laser medium and the second end mirror, wherein at least one of the optical elements of the first resonator section has a focusing design, by which the beam axes of the laser beam, which result upon respective tilts of at least one of the optical elements arranged in the second resonator section, have at least one intersection point, and wherein this intersection point or one of these intersection points of the beam axes of the laser beam lies in the pump region of the laser medium or has a distance from the pump region which is less than the Rayleigh length, which corresponds to a section of the laser beam which lies between the laser medium and the closest focusing optical element of the first resonator section.

### BACKGROUND

In general, laser resonators (which are also designated as cavities) are required, in which the laser beams are guided through the laser medium (=active medium). In addition to standing wave resonators (also designated as linear resonators), in which the laser light runs back and forth between two end mirrors, ring resonators are also known, in which the laser light is guided circumferentially, wherein fundamentally two circumferential directions are possible.

Mode-coupled femtosecond or picosecond lasers are typically designed with a folded resonator (=“extended cavity”), in particular if the pulse repetition frequency is to be in the megahertz range. In order to allow a compact structure with such a repetition frequency, multiple folding mirrors or deflection mirrors are used. The laser beam is incident thereon at an angle of incidence close to 0° (±10°) to the surface normal on the main plane of the folding mirror. Such folding mirrors can be designed as planar or can have a curvature, so that they are designed as concave mirrors. For example, a femtosecond laser at 20 MHz has a resonator length of 7.5 m. The number of required reflections on folding mirrors results from the length of the laser housing. For example, laser housings having a length of 56 cm are commercially available. Frequently used pulse repetition frequencies are in the range of 20-120 MHz.

One problem in such resonators is the sensitivity in relation to tilts of optical elements of the resonator. Commercially available resonators have such a sensitivity in relation to tilts of the optical elements in the case of some optical elements that in the event of a tilt of the optical element in relation to the aligned (=optimal) state by an angle amount of 50 μrad, a loss of performance of multiple percent occurs, as a result of displacements of the beam axis of the laser mode in relation to the pump region of the laser medium.

The optical elements of a laser resonator are typically installed on a shared carrier part, which is formed by a plate, a monolithic block, or a mechanically stable linkage. The mirror elements of the resonator, which consist of the actually reflective mirror coating and the substrate (typically made of glass) to which the mirror coating is applied, are framed in—typically metal—mirror mounts, which are then in turn fastened on the carrier part. The problem results that various materials touch one another: glass (as the mirror substrate), on the one hand, and metals such as aluminum and stainless steel, on the other hand. The thermal expansion is significantly different, so that in the event of changes of the temperature, either a tension and/or a displacement to one another result.

An angle stability of better than 50 μrad is achievable with technical difficulty or only with high expenditure upon the installation of materials having different coefficients of expansion (in consideration of environmental influences and over a multiyear time span): this means that a mirror surface having an expansion of 10 mm can deviate at one end in relation to the other end by at most 0.5 μm. If one considers that multiple mirror elements can add up their tolerances, the stability requirement for the individual mirrors is thus to be significantly increased. The surface roughness of milled or drilled metal surfaces is typically 0.4 to 0.8 μm and therefore typically cannot offer the desired support precision.

Pulsed laser beams can also be generated in a different manner than by mode coupling, in particular by a Q-switch. Typical pulse durations are in the nanosecond range here.

A mode-coupled femtosecond solid-state laser is described, for example, in F. Brunner et al., “Diode-pumped femtosecond Yb:KGd(W04)2 laser with 1.1-W average power”, OPTICS LETTERS, 2000, volume 25 (15), 1119-1121. The folded standing wave resonator is designed here in the form of a so-called “delta cavity”. The laser medium formed by Yb:KGW is arranged in the laser beam in the region between two concave mirrors of the resonator, which each have a radius of curvature of 200 mm. The laser beam is strongly constricted at the location of the laser medium in relation to its expansion at these concave mirrors. The beam radius (or mode radius) at the location of the laser medium is less than 1/10 of the beam radius at the concave mirrors in this case. The mirrors of this resonator have relatively high sensitivities in relation to tilts.

Delta configurations of resonators are known in many further embodiments. Other known designs of resonators are, for example, so-called Z configurations.

Further designs of pulsed lasers, in particular mode-coupled lasers, are disclosed, for example, in EP 1 692 749 B1, EP 1 588 461 B1, and EP 1 687 876 B1, as well as the publications cited therein.

Considerations on measures for reducing alignment sensitivities of optical elements of a resonator are already contained, for example, in above-mentioned EP 1 588 461 B1. An adaptation element to compensate for alignment errors is used here, wherein a back reflection of the laser beam occurs in itself or slightly offset, in particular through a curved mirror, or the laser beam is guided in a collimated manner on a resonator mirror, in particular by a reflective or refractive element. Considerations on the alignment sensitivity of the optical elements of resonators are also disclosed, for example, in “Encyclopedia of Laser Physics and Technology” www.rp-photonics.com/alignment_sensitivity.html. This encyclopedia has also been published in book form as “Encyclopedia of Laser Physics and Technology”, Paschotta, Rüdiger, 2008, ISBN-10:3-527-40828-2 (Wiley-VCH, Berlin).

The integral design with one another or the rigid connection of two optical elements of the resonator is disclosed in the European patent application having the application number EP 09167189.1, which has earlier priority and has not been previously published, in order to decrease the tilt sensitivity in relation to these optical elements with respect to the location of the beam axis or its inclination in the case of another of the optical elements of the resonator. The tilt in the same direction of these two coupled optical elements has opposing effects in this case on the location of the beam axis or its angle in the other of the optical elements.

The object of the invention is to provide a laser of the type mentioned at the beginning, in which an improvement is achieved with respect to the tilt sensitivity of at least one of the optical elements of the resonator. This is achieved according to the invention by a laser having the features of claim 1.

In the laser of the invention, at least one of the optical elements of the first resonator section has a focusing design. If only the first end mirror is arranged in the first resonator section as the optical element, it is thus designed as a concave mirror. If, in addition to the first end mirror, at least one further optical element is arranged in the first resonator section, the first end mirror and/or at least one of the further optical elements arranged in the first resonator section is designed as focusing. Such a design is typical. If, with such a design, starting from an aligned state, at least one of the optical elements of the second resonator section is tilted in relation to its aligned location, a change of the beam location of the laser mode occurs, i.e., of the beam axis (=optical axis) of the laser beam in the resonator. The beam axes occurring upon different tilts of one of the optical elements of the second resonator section and/or upon tilts of different optical elements of the second resonator section intersect in this case in one shared intersection point, which lies between two optical elements of the resonator, or in two or more intersection points, which each lie between two optical elements of the resonator. The laser medium is arranged so that this intersection point or, in the case of more than one intersection point, one of these intersection points lies in the pump region of the laser medium or close thereto. The distance from the intersection point to the pump region is less for this purpose in any case than the Rayleigh length, which is assigned to the section of the laser beam which lies between the laser medium and the closest focusing optical element of the first resonator section (which can optionally be the single focusing optical element of the first resonator section).

Through this arrangement of the laser medium, upon tilts of optical elements in the second resonator section at the point of the pump region of the laser medium, no displacement (if the intersection point lies in the pump region) or only a minor displacement (if the intersection point has a small distance from the pump region) of the beam axis in relation to the pump region occurs, but rather only an angle change of the beam axis. The sensitivity of the laser with respect to its performance in relation to tilts of the optical elements lying in the second resonator section has thus been reduced practically to zero. Only the optical elements of the first resonator section are alignment-sensitive in this meaning, wherein the first resonator section can only have the first end mirror as the single optical element, for example.

Instead of a tilt or in addition thereto, a misalignment of an optical element can also have a transverse displacement in relation to its aligned position. This can occur, for example, because of (thermal) tensions. In the case of flat mirrors, the beam location does not thus change, however, in the case of curved mirrors or lenses, such a lateral displacement can be represented as a possibly additional contribution to the tilt, which is dependent on the radius of curvature. For a misalignment in the meaning of a lateral displacement, analogous statements therefore apply for curved mirrors and lenses as previously made in conjunction with the tilt. A change of the beam axis also occurs here, wherein the different beam axes intersect in at least one intersection point, and in the same way as upon a tilt alone.

The beam axis, which is formed in the aligned state of the optical elements, i.e., without misalignment, and thus represents the “ideal” optical axis of the laser beam or laser mode, is designated hereafter as the central axis of the laser beam. This central axis preferably intersects the main plane of the respective optical element at the intersection point of the main plane of this optical element with the axis of symmetry of this optical element.

Tilts of the optical elements for determining the at least one intersection point are preferably considered to be those tilts which occur starting from the aligned location of the respective optical element around a respective tilt axis, which is perpendicular to the axis of symmetry of the optical element and extends through the intersection point of the main plane of the optical element with its axis of symmetry. The angle range of the tilts is within the limits in which the laser mode still forms in any case. Furthermore, the tilt range is in the limits within which the laser beam still lies with its entire beam diameter inside the optical surfaces of the optical elements. The optical surfaces are the surfaces of the optical elements which interact with the laser beam. These can be reflecting surfaces (of mirrors) and also transmitting surfaces (in lenses, if such are present) and also a combination thereof (e.g., in a decoupling mirror).

In practice, if tilts around axes other than the above-mentioned tilt axis occur, they can be considered to be a superposition of a tilt around the mentioned tilt axis with a transverse displacement and a displacement in the direction of the central axis. Displacements in the direction of the central axis can in general remain unconsidered as an approximation.

The laser medium is also an optical element having optical surfaces, which influences the laser beam. Thus, a thermal lens is formed by the laser medium (however, in this publication only the optical elements provided in addition to the laser medium, which guide the laser beam, are considered to be optical elements of the resonator).

If more than one intersection point of the laser beams is provided, the pump region of the laser medium is preferably placed in or close to the intersection point which is closest to the first end mirror. The number of the alignment-sensitive optical elements can thus be minimized.

### SUMMARY

According to the invention, the radius of the laser beam (=radius of the laser mode), at least over the section of the laser medium which lies between the laser medium and the closest focusing optical element of the first resonator section, is less than five times, preferably less than three times, particularly preferably less than twice the radius of the laser beam in the pump region of the laser medium. Therefore, relatively small changes of the beam radius or relatively small divergences or convergences of the laser beam thus exist at least over this section of the laser beam. In the design according to the invention, the tilt sensitivity of at least one optical element of the first resonator section, in particular the focusing element of the first resonator section or one of the focusing elements of the first resonator section (preferably at least the one closest to the laser medium) and/or at least one additionally provided folding mirror of the first resonator section can thus be decreased. In advantageous embodiments of the invention, the radius of the laser beam in the entire first resonator section is less than five times, preferably less than three times, particularly preferably less than twice the radius of the laser beam in the pump region of the laser medium.

The tilt sensitivity with respect to the performance in the event of a tilt of 100 μrad can be less than 5% for all optical elements of the first resonator section, for example (the tilt or alignment sensitivity in percent is explained hereafter).

In the design according to the invention, the distance of the pump region of the laser medium from the focusing optical element of the first resonator section or, in the case of multiple focusing optical elements in the first resonator section, from the closest focusing optical element of the first resonator section, is advantageously less than three times the value of the Rayleigh length, which corresponds to the section of the laser beam (in relation to its actually formed or interpolated beam waist) which lies between the laser medium and the closest focusing optical element of the first resonator section. The interpolated beam waist is to be used in this case, for example, if the laser beam is already incident on the laser medium before reaching the beam waist (wherein the focusing is changed by the thermal lens formed by the laser medium). The distance of the pump region of the laser medium from the closest focusing optical element is determined in this case, if a planar folding mirror is located between the laser medium and this focusing optical element, in the unfolded state of the resonator, of course.

The unfolded state of the resonator results in a known manner in that the z axis of the resonator, along which the beam axis of the laser beam extends in the aligned state of the optical elements, is represented as linear.

The distance from the beam axis at which the intensity of the laser beam decreases to a value of 1/e2 (approximately 13.5%) is used as the radius of the laser beam or the laser mode. The diameter of the laser beam is twice the value of the radius of the laser beam.

The length of the pump region of the laser medium, in relation to the direction of the central axis of the laser beam, preferably in relation to all beam axes upon tilts of optical elements, is advantageously shorter than one-half the value of the Rayleigh length, particularly preferably less than one-fifth the value of the Rayleigh length.

The intersection point, which lies in or close to the pump region of the laser medium, is advantageously located between the first and the second resonator sections.

The focal length of the focusing optical element of the first resonator section or, in the case of multiple focusing optical elements in the first resonator section, the focusing optical element closest to the laser medium in the first resonator section, is, in an advantageous embodiment of the invention, less than 100 mm, preferably less than 50 mm. Depending on the embodiment, this focal length can also be less than 20 mm or also less than 10 mm, wherein values of less than 5 mm are also possible. Therefore, relatively strongly focusing optical elements are advantageously used, from which the laser medium has a relatively small distance.

As already mentioned, the resonator of a laser according to the invention is particularly designed as folded, i.e., as a so-called “extended cavity”. In this case, in addition to the first and second end mirrors, at least one folding mirror (deflection mirror), which deflects the laser beam, in particular by greater than 160°, is provided. The laser beam is thus incident thereon at an angle of incidence of 0° to 10° to the surface normals on the main plane of the folding mirror. Multiple such folding mirrors are preferably provided, for example, four or more. In advantageous embodiments, more than ten such folding mirrors can also be provided.

Depending on the embodiment, the unfolded length of the resonator is more than 1 m, in particular more than 5 m, wherein shorter resonator lengths can also be provided in other embodiments.

The length of the first resonator section is less than 200 mm, preferably less than 100 mm, in an advantageous embodiment of the invention. In further advantageous embodiments, this length is less than 40 mm, preferably less than 20 mm.

The length of the first resonator section is preferably less than one-fifth of the length of the second resonator section, particularly preferably less than one-tenth of the length of the second resonator section. In further advantageous embodiments, the length of the first resonator section is less than one-fiftieth of the length of the second resonator section.

When the length of a resonator section is mentioned, this refers to the length in the unfolded state.

In an advantageous embodiment of the invention, the laser is designed as a pulsed laser. For example, a mode coupling can be provided, wherein the pulse duration can particularly be in the femtosecond range or picosecond range. In other embodiments, Q-switches can be provided, wherein the pulse duration can be in the nanosecond range in particular.

In the design as a pulsed laser, the local length of the pulse is advantageously less than the unfolded resonator length, preferably less than one-tenth of the unfolded resonator length.

For the pulse repetition rate, values of less than 150 MHz are favorable in many embodiments, wherein the unfolded length of the resonator is accordingly greater than 1 m. Advantageous designs provide pulse repetition rates of less than 50 MHz, i.e., resonator lengths of greater than 3 m. With designs of pulse repetition rates of less than 30 MHz, the resonator length is accordingly greater than 5 m. Decreased tilt sensitivities are of particular significance in particular in long resonators having many folding mirrors.

To calculate the displacement and angle deviation of the beam axis of the laser beam (r, r′) in the event of a tilt of an optical element in relation to the central axis or ideal axis (without tilts), the calculation method can be used as is described, for example, by Siegman Anthony E.: “Lasers”, University Science Books, 1986, pages 607-614. An expansion of the known ABCD matrix search method for calculating laser cavities to the so-called ABCDEF search method is described therein. The tilt sensitivity of resonators can be calculated by means of the matrix element “F” by this method. For this purpose, an additional imaginary tilt element is incorporated in the resonator in the place of an observed optical element for which the tilt sensitivity is to be determined. If the observed optical element is a folding mirror and the effect of a tilt of the folding mirror by 100 μrad is to be ascertained, the tilt element has a 3×3 matrix having the following values ABCDEF (100 μrad)={A, B, E; C, D, F; 0, 0, 1}={1, 0, 0; 0, 1, 2e-4; 0, 0, 1}. It is taken into consideration here that due to the tilt of the folding mirror by 100 μrad, a tilt of the optical axis by 200 μrad occurs, so that a value of 2e-4 is assigned to the angle tilt value F in the matrix of the tilt element. Upon the consideration of the tilt of a lens by 100 μrad, F=1e-4 would be used as the tilt value.

To calculate the starting coordinates for the optical axis of the laser beam at the first end mirror having a tilt element ABCDEF (100 μrad) incorporated at the point Z in the resonator, an eigenvector calculation is carried out. The starting coordinates (r0, r′0) are calculated, at which these starting coordinates of the beam axis in one resonator revolution are again mapped “in themselves”. For the calculation, the vector (r, r′, 1) is used, wherein r represents the transverse displacement of the laser axis and r′ represents its inclination in relation to the central axis. If there are no tilts of optical elements, i.e., all elements F are each 0, (r0, r′ 0)=(0, 0).

It follows from the requirement of mapping the starting coordinates of the optical axis after one resonator revolution “in themselves” that all beam axes of the laser beam forming at different tilts must be perpendicular to the optical surface of the first end mirror (this also applies for the second end mirror).

The propagation of the beam axis through the resonator, starting from the starting coordinates, is calculated in that each individual optical element, i.e., its associated ABCDEF matrix, is multiplied by the vector (r, r′, 1). The deviation r, r′ of the beam axis from the central axis (i.e., without tilt of an optical element) is thus obtained for each optical element at a given point z in the resonator. The extension of the “intrinsic axis” (r, r′) for a given tilt of one of the optical elements over the entire resonator is thus obtained.

From the deviation (rmed, rmed′) of the beam axis of the laser beam at the point of the laser medium if one of the optical elements is tilted, for example, by 100 μrad, the effect of this tilt on the performance of the laser can be ascertained. Thus, in particular the value rmed specifies the displacement of the beam axis in the laser medium in relation to the aligned or optimal state (this aligned state would be given by rmed=0). The ratio of the displacement rmed of the beam axis in relation to the beam radius (mode radius) wmed in the laser medium, to which the radius of the pump region is adapted, can be used as a quantitative measure of the tilt sensitivity or alignment sensitivity of the laser resonator for the tilt of the observed optical element by 100 μrad, wherein the alignment sensitivity is specified in %. Values of 10% and greater typically result in a noticeable tilt sensitivity, values significantly greater than this result in an undesirably high tilt sensitivity.

The calculation is based on the paraxial approximation. The beam path within the laser resonator is at least partially, preferably completely, designed as a free space optic, i.e., it is not guided in a waveguide (made of a medium other than air) between the optical elements.

The tilt of one of the optical elements was never previously observed. The value E in the ABCDEF matrix for the misalignment of an optical element in the meaning of a transverse displacement was set to 0. The calculation can be used in an analogous manner for the transverse displacement of an observed optical element, wherein a corresponding value is assigned to the matrix element “E”. For optical elements having curved surfaces (curved mirrors and lenses) an (additional) tilt of the optical element can instead be used as an approximation.

The beam location parameters of the decoupled output beam of the laser can be of interest, since a laser is typically integrated in an optical application system, which has tolerances for the incoming laser beam in its location (position and angle at a defined point). In addition to the effect of the tilt (and/or transverse displacement) of an optical element on the performance of the laser, it is therefore also of interest to what extent a transverse displacement and/or angle deviation of the beam axis at the decoupling element of the laser occurs in the event of a tilt (and/or transverse displacement) of an optical element. This may be calculated using the same method, specifically by means of propagation of the starting value of the beam axis (r0, r′0) through the resonator with the aid of the ABCDEF matrix calculation up to the decoupler (if the decoupler does not correspond to the beginning of the resonator in any case).

In order to decrease the sensitivity of the transverse displacement and/or angle deviation of the beam axis at the decoupler, it is preferable to have at least two optical elements of the resonator, which have opposing effects on the transverse displacement and/or angle deviation of the beam axis at the decoupler in the event of a tilt in the same direction, wherein these two optical elements are located at different points z in the resonator, are integrally designed with one another or are rigidly connected to one another, and are jointly installed on a carrier part of the resonator. In particular, these two optical elements can be two folding mirrors. Therefore, at least one further folding mirror is located between these two folding mirrors, which are integrally designed with one another or rigidly connected to one another and are jointly installed.

In the case of the integral design, the optical surfaces of the two optical elements are located on a shared base body. In the case of the rigid connection of the two optical elements, the optical surfaces of the two optical elements are located on different bodies, which are rigidly connected to one another, and which are installed via a shared mount on a carrier part of the resonator, wherein they can preferably be jointly aligned. At least a part of the further optical elements of the resonator are also installed on the carrier part, specifically via separate mounts.

If the two optical elements, which are formed integrally with one another or rigidly connected to one another, have opposing effects on the displacement and/or angle deviation in one of the other of the optical elements of the resonator in the event of a tilt in the same direction, through such an integral design or rigid connection of two optical elements, the displacement and/or angle deviation of the beam axis resulting upon a tilt of these optical elements can be decreased in the case of this other optical element. For example, a reduction of the change of inclination of the output beam can be significant. The displacement and/or the angle deviation of the beam axis is thus decreased in an optical element of the laser, which is sensitive in relation to such a displacement and/or angle deviation. For example, this optical element, which is sensitive in particular in relation to a displacement, could be an acousto-optic or electro-optic modulator.

In an advantageous embodiment of the invention, the optical surfaces of the two optical elements, which are integrally designed with one another or rigidly connected to one another, are curved and have different centers of curvature and/or radii of curvature and lie in planes angled to one another, or the optical surface of one of these two optical elements is curved and the optical surface of the other of these two optical elements is flat.

### BRIEF DESCRIPTION OF THE DRAWINGS

Further advantages and details of the invention will be explained in greater detail hereafter on the basis of the appended drawing. In the figures:

FIG. 1 shows a schematic illustration of a laser arrangement according to the prior art;

FIG. 2 shows an illustration of the beam radius (mode radius) and the optical elements of the resonator in the unfolded state according to a second embodiment according to the prior art;

FIG. 3 shows a schematic fundamental illustration of a laser arrangement according to a possible embodiment of the invention;

FIG. 4 shows a schematic illustration of a specific laser arrangement according to a first exemplary embodiment of the invention;

FIG. 5 shows the illustration of the beam radius for the embodiment of FIG. 4, in the unfolded state of the resonator;

FIGS. 6 and 7 show analogous illustrations to FIGS. 4 and 5 for a second concrete exemplary embodiment of the invention;

FIG. 8 shows a schematic illustration of a further possible embodiment of the invention;

FIGS. 9 and 10 show analogous illustrations to FIGS. 4 and 5 for a third concrete exemplary embodiment of the invention;

FIG. 11 shows an enlarged detail of FIG. 10;

FIGS. 12 and 13 show schematic exemplary embodiments for two coupled optical elements of the resonator.

### DETAILED DESCRIPTION OF THE PREFERRED EMBODIMENTS

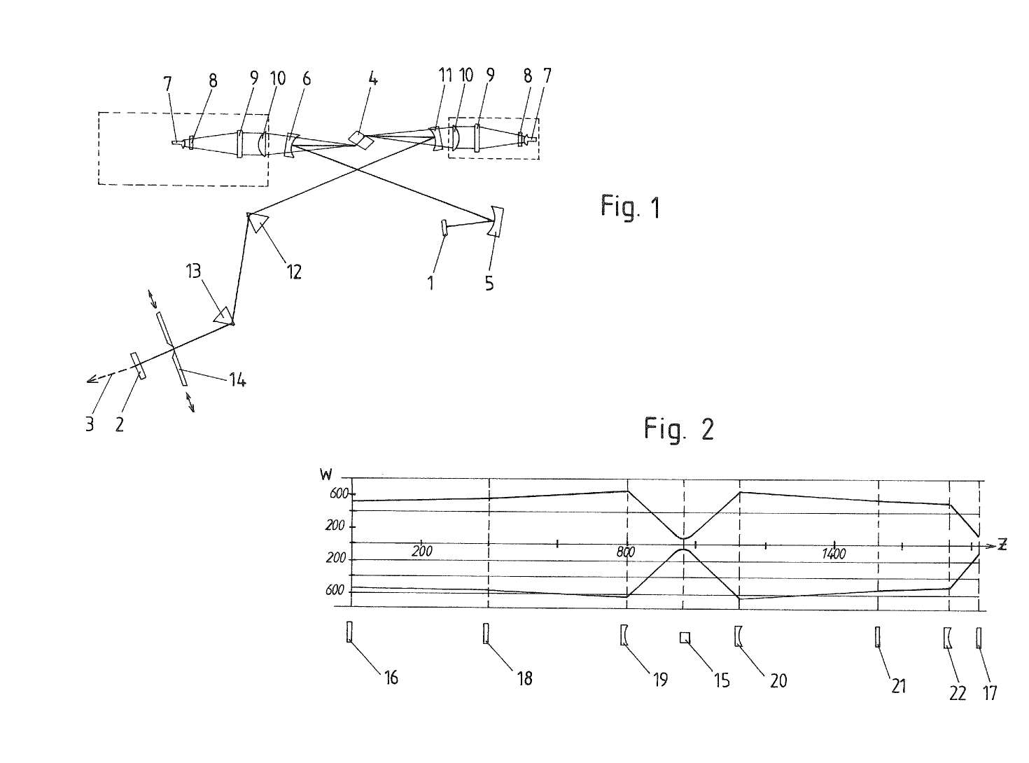

A laser arrangement according to the prior art corresponding to above-mentioned article by F. Brunner et al., “Diode-pumped femtosecond Yb:KGd(W04)2 laser with 1.1-W average power”, OPTICS LETTERS, 2000, volume 25 (15), 1119-1121 is schematically shown in FIG. 1. A laser medium 4 in the form of Yb:KGW is arranged in a standing wave resonator. The laser arrangement comprises a resonator having a first end mirror 1, which is designed to exert a mode locking function as a SESAM mirror. The resonator also comprises a second end mirror 2, which is designed here by a partially-transparent design as the decoupler for the output beam 3 of the laser. Folding mirrors 5, 6 in the form of spherical concave mirrors having radii of curvature of 200 mm are arranged between the first end mirror 1 and the laser medium 4 as further optical elements. The folding mirror 6 is designed in this case as a dichroic mirror and the pumping of the laser medium 4 occurs through it. A laser diode 7 is used for this purpose, whose beam is guided through optical elements 8, 9, 10 and through the folding mirror 6 into the laser medium 4. A folding mirror 11, prisms 12, 13, and an aperture 14 are arranged between the second end mirror 2 and the laser medium 4. In an analogous way as by the folding mirror 6, optical pumping of the laser medium 4 is performed by the folding mirror 11 by means of a second laser diode 7 and optical elements 8, 9, 10.

In the further embodiment according to the prior art shown in FIG. 2 on the basis of the beam diameter of the unfolded cavity and the associated optical elements schematically shown thereunder, Ti:sapphire is used as the laser medium 15. The resonator, in which the laser medium 15 is arranged, comprises a planar first end mirror 16, which is used as the decoupler for the laser beam, a planar second end mirror 17, which is implemented for mode coupling as a SESAM mirror, and folding mirrors 18, 19, which are arranged between the first end mirror 16 and the laser medium 15, of which the folding mirror 18 is planar and the folding mirror 19 is a concave mirror having a radius of curvature of 300 mm, as well as folding mirrors 20, 21, 22 arranged between the laser medium 15 and the second end mirror 17, of which the folding mirror 20 is a concave mirror having a radius of curvature of 300 mm, the folding mirror 21 is a planar mirror, and the folding mirror 22 is a concave mirror having a radius of curvature of 200 mm. The distances of the optical elements 16-22 of the resonator and the position of the laser medium 15 in the resonator can be inferred from FIG. 2, since their positions are shown on the ordinate (=z axis, which indicates the distance from the first end mirror 16 in the unfolded state of the resonator), whose scale is indicated in millimeters. The distance between the laser medium 15 and the adjacent folding mirrors 19, 20 is respectively 160 mm. The laser medium 15 has a thickness of 1 mm. The abscissa indicates the radius of the laser beam in micrometers (tangential on top, sagittal on the bottom). The radius of the laser beam over the extension of the z axis is shown.

It is clear from FIG. 2 that the laser beam has a pronounced constriction at the location of the laser medium, which is caused by use of the curved folding mirrors 19, 20, whose radius of curvature is respectively 300 mm. In the two concave mirrors 19, 20, the mode radius is more than ten times as large as in the laser medium 15.

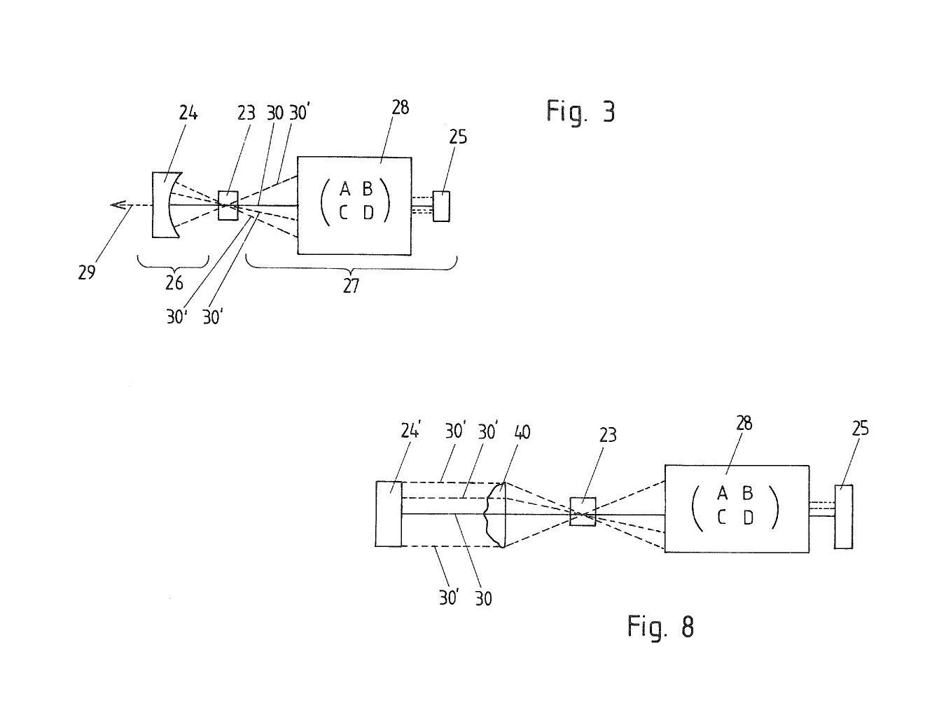

FIG. 3 shows a schematic illustration of a first possible embodiment of the invention. The laser has the active laser medium 15. In particular, this is a solid-state laser. For example, the laser medium 23 can be Yb:KYW (with, e.g., 5% Yb doping) or also other tungstates doped with ytterbium, e.g., Yb:KGW. The laser medium 23 is arranged in a standing wave resonator, which comprises a first end mirror 24 and a second end mirror 25. In this embodiment, the first end mirror 24 is the single focusing optical element of the first resonator section 26. Other optical elements, for example, one or more planar folding mirrors, could be arranged between the first end mirror 24 and the laser medium 23, however.

The second resonator section 27 comprises, in addition to the second end mirror 25, further optical elements. These are symbolized here in their entirety by the ABCD matrix 28 of the overall system of these optical elements. These further optical elements of the second resonator section 27 can be formed by one or more folding mirrors or can comprise such folding mirrors, for example.

The decoupling of the output beam 29 indicated by a dashed line in FIG. 3 can occur through the first end mirror 24, for example. Decoupling through the second end mirror 25 or through another of the optical elements of the resonator is also possible.

The pumping of the laser medium 23 is not shown in FIG. 3. For example, this could occur through the first end mirror 24, which is designed as dichroic for this purpose (the decoupling would then occur at another optical element). Concrete examples of the pumping are described hereafter.

This is preferably a pulsed laser. The pulse repetition rate can be relatively low, for example, less than 30 MHz, which results in a correspondingly large overall length of the resonator and a corresponding number of folding mirrors, to nonetheless achieve a compact design, e.g., having four or more folding mirrors. In particular, the laser can be designed as a mode-coupled laser. In order to achieve mode coupling, a saturable absorber can be provided, for example, one of the end mirrors or one of the folding mirrors can be designed as a saturable absorber mirror, such as a SESAM mirror. Other passive mode couplings, as through the Kerr lens effect, or active mode couplings through acousto-optic modulators or electro-optic modulators such as the Pockels cell, can also be provided.

If short pulse durations are desired, in particular in the picosecond range or shorter, at least one of the mirrors of the resonator is designed having a negative group speed dispersion.

A pulsed laser, in particular having pulse durations in the nanosecond range, could instead be achieved by a Q-switch. Furthermore, the laser could also be continuously operated, i.e., as a continuous beam laser.

If the optical elements of the resonator have their ideal locations (=“aligned locations”), i.e., there is no misalignment in the form of a tilt and/or transverse displacement, the central axis indicated as a solid line in FIG. 3 thus results for the beam axis 30 (=optical axis) of the laser beam or laser mode. In the event of a tilt of one or more of the optical elements in the second resonator section 27, deviations occur from this central axis. Some such deviating beam axes 30′ are indicated in FIG. 3 by dashed lines. At each point z (=distance from the first end mirror 24 or from its middle plane in relation to the unfolded state of the resonator), there is a distance (r) of the beam axis 30′ resulting upon a tilt from the central axis 30 and an angle (r′) in relation thereto. Since the beam axes of laser modes which form must be perpendicular to the optical surface of the first end mirror 24, the beam axes 30, 30′ intersect in a shared intersection point 31. The laser medium 23 is arranged so that this intersection point 31 comes to rest in the pump region of the laser medium 23, i.e., is arranged here at a distance from the first end mirror 24 which is equal to the radius of curvature of the first end mirror 24. Upon a transverse displacement of one of the optical elements, either the beam axis 30 remains unchanged (upon a displacement of a planar mirror) or this displacement results in a deviating beam axis 30′, which also leads through the intersection point 31. The sensitivity relating to the laser performance in the event of a tilt and/or displacement of those elements which are located in the second resonator section 27 has thus been reduced to 0.

A low sensitivity can also be achieved by an arrangement of the pump region of the laser medium 23 close to the intersection point 31, wherein the distance from the intersection point 31 is less than the Rayleigh length, which corresponds to the section of the laser beam which lies between the laser medium 23 and the closest focusing optical element of the first resonator section, which is the first end mirror 24 here.

A tilt or transverse displacement of one or more of the optical elements lying between the second end mirror 25 and the laser medium 23 can be represented by an ABCDEF matrix of the overall system of these optical elements.

The system ABCD is selected by a person skilled in the art in accordance with the desired properties, e.g., length of the resonator, number and position of folding mirrors for the purpose of compaction, desired beam radius w in the laser medium, desired beam cross-section at the second end mirror 25 (in particular if this exerts, e.g., a mode-locking function such as, e.g., a SESAM mirror), radius of curvature of the first end mirror, etc. For the second end mirror 25, a concave mirror can also be used instead of a planar mirror.

The size of the pump region of the laser medium 23 is typically adapted to the beam diameter of the laser mode in such a manner that the respective beam diameters at the location of the laser medium are approximately equal. The optimum is ascertained by experiment. At a beam diameter of the laser mode of 200 μm (i.e., radius w=100 μm) in the laser medium 23, it can be a good approach to also design the pump beam diameter in the laser medium to be approximately 200 μm. This is achievable in the concrete structure, for example, in that the light of a commercially available, fiber-coupled pump laser diode having a core diameter of 200 μm and a numeric aperture of 0.22 is mapped with a simple 1:1 mapping in the laser medium, e.g., using two lenses of equal focal length, of which the first assumes the function of collimation and the second assumes the function of refocusing.

The tilts which result in beam axes 30′ deviating from the central axis 30 can be, for example, at +/−100 μrad and/or +/−200 μrad and/or +/−300 μrad.

The radius of the laser beam in the first resonator section 26 is also less than five times the value of the radius of the laser beam in the pump region of the laser medium, preferably less than three times.

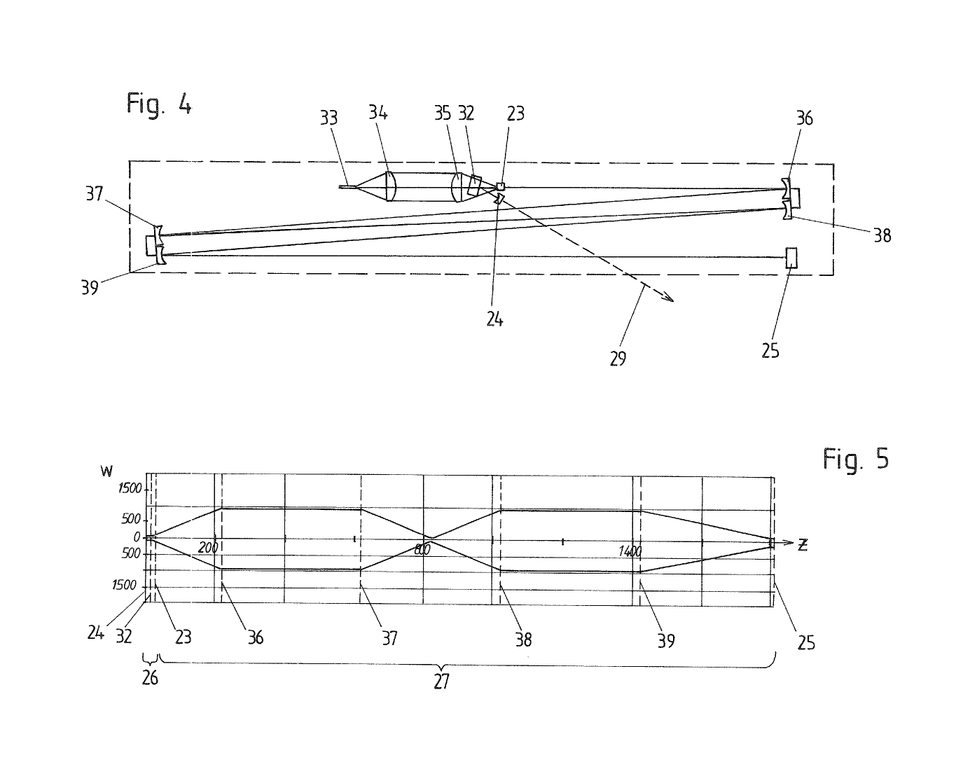

A concrete exemplary embodiment for a structure corresponding to the schematic diagram of FIG. 3 is schematically shown in FIG. 4. The first end mirror 24 is formed by a concave mirror having a radius of curvature of 25 mm. The distance of the laser medium 23 from the first end mirror 24 (in relation to the unfolded state) is equal to the radius of curvature of the first end mirror 24, i.e., 25 mm in the present exemplary embodiment. Furthermore, a planar, dichroically coated folding mirror 32, which represents the pump coupling mirror, is located between the first end mirror 24 and the laser medium 23. The pumping is performed in the above-described manner by means of a laser diode 33 and the two lenses 34, 35. The laser medium is formed, for example, by Yb:KYW with, e.g., 5% Yb doping. For example, the laser medium can have a thickness of 1 mm (measured in the z direction).

The first end mirror 24 and the folding mirror 32 together form the first resonator section.

The second end mirror 25 is formed by a planar mirror, optionally by a SESAM mirror for mode coupling. Folding mirrors 36-39 are used between the laser medium 23 and the second end mirror 25 to fold the laser beam. The folding mirror 36 is arranged at a distance of 182 mm from the laser medium 32 and has a radius of curvature of 400 mm. The folding mirror 37 is arranged at a distance of 400 mm from the folding mirror 36 and has a radius of curvature of 400 mm. The folding mirror 38 is arranged at a distance of 400 mm from the folding mirror 37 and has a radius of curvature of 400 mm. The folding mirror 39 is arranged at a distance of 400 mm from the folding mirror 38 and has a radius of curvature of 800 mm. The second end mirror 25 is arranged at a distance of 400 mm from the folding mirror 39.

The total length of the resonator is 1809 mm for the single distance, and 3618 mm for the cycle. The cycle time is therefore approximately 12 ms, which results in a pulse repetition rate of 82.9 MHz (in the case of mode coupling).

This resonator has a beam radius of approximately 100 gm at the location of the laser medium.

The laser can be installed, for example, in a housing having a length of 450 mm and a width of 71 mm.

The folding mirror 32 could be omitted and pumping could be performed directly through the first end mirror 24, if it is coated to be dichroically reflective, i.e., highly reflective at 1040 nm and simultaneously highly transmitting for the pump wavelength of 981 nm, which is typical in the case of Yb:KYW. The decoupling of the output beam 22 could then occur, for example, at the second end mirror 25. The mode coupling could then be implemented by one of the other optical elements.

The folding mirrors 36, 38 and the folding mirrors 37, 39 are advantageously coupled to one another, as explained in greater detail hereafter.

FIG. 5 shows an analogous illustration to FIG. 2 of the radius of the laser beam in micrometers measured as a function of the distance from the first end mirror 24 (with respect to the unfolded state of the resonator), i.e., in the z direction. The points at which the optical elements and the laser medium are arranged are identified by dashed lines and these lines are designated with the reference signs of these elements. The first and second resonator sections 26, 27 are also indicated.

As is obvious from FIG. 5, the radius of the laser beam in this exemplary embodiment is less in the entire first resonator section than the radius of the laser beam in the laser medium.

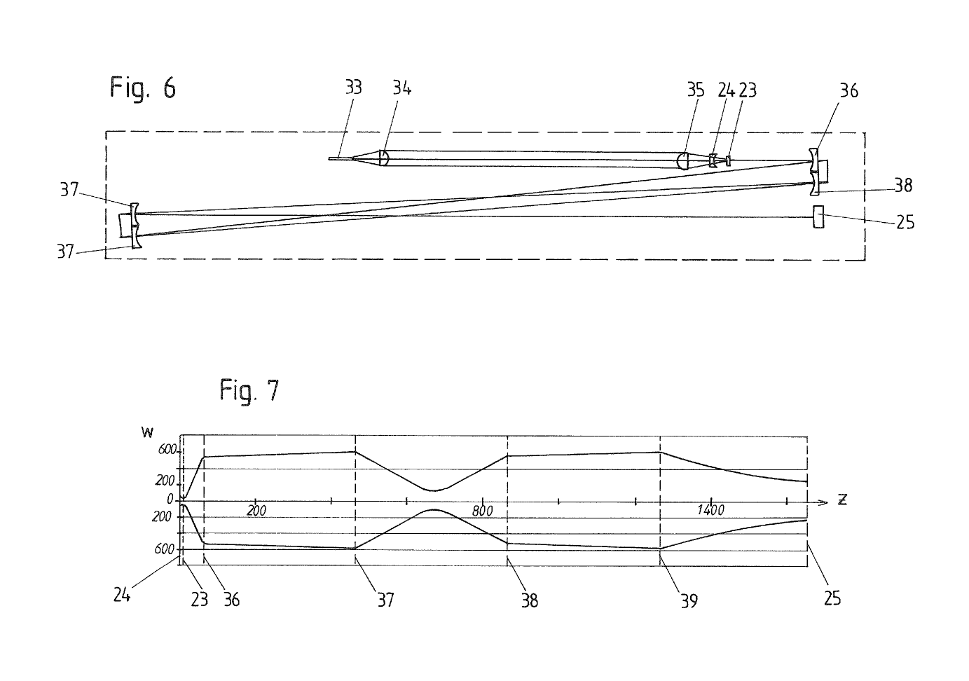

FIGS. 6 and 7 show analogous illustrations to FIGS. 4 and 5 for a second concrete exemplary embodiment. Analogous parts are provided with the same reference signs. The first end mirror has a radius of curvature of 6.5 mm here and the distance of the laser medium 23 from the first end mirror is accordingly 6.5 mm. The laser medium 23 corresponds to that of the first exemplary embodiment. The pumping of the laser medium is performed in the above-described manner, directly through the first end mirror 24 here. The folding mirror 36 has a radius of curvature of 100 mm and is located at a distance of 48 mm from the laser medium 23. The folding mirror 37 has a radius of curvature of 400 mm and is located at a distance of 400 mm from the folding mirror 36. The folding mirror 38 has a radius of curvature of 400 mm and is located at a distance of 400 mm from the folding mirror 37. The folding mirror 39 has a radius of curvature of 800 mm and is located at a distance of 400 mm from the folding mirror 38. The second end mirror 25 is designed as planar and is located at a distance of 400 mm from the folding mirror 39.

The second end mirror 25 can be used as the decoupler for the output beam (not shown here). Mode coupling could then be assumed by another optical element. On the other hand, the second end mirror 25 could also be designed as a mode coupler, wherein another optical element forms the decoupler for the output beam.

The beam radius in the laser medium is approximately 35-40 μm here.

In a further concrete exemplary embodiment, a larger beam radius could also be achieved in the laser medium, for example, of 170 μm. For this purpose, the first end mirror 24 could have a radius of curvature of 75 mm and the laser medium 23 could thus be arranged at a distance of 75 mm from the first end mirror. The folding mirror 36 could be arranged at a distance of 136 mm from the laser medium 23 and have a radius of curvature of 400 mm. The folding mirrors 37-39 and the second end mirror 25 could be designed according to the first and second concrete exemplary embodiments and have the distances to one another or from the folding mirror 36 specified therein. Such a design would be suitable, for example, for the operating mode of a regenerative amplifier, in which higher energies and peak performances prevail, so that the optical destruction threshold can represent a problem.

FIG. 8 shows a schematic diagram of a further possible fundamental embodiment. A planar mirror is used here as the first end mirror 24′ and a focusing optical element, for example, in the form of a concave mirror, is located between the first end mirror 24′ and the laser medium 23 as a further optical element of the first resonator section 26. The second resonator section 27 has the second end mirror 25 and further optical elements, which are combined here into a common ABCD matrix 28, as the optical elements. The beam axis 30, which represents the central axis without a misalignment of optical elements of the second resonator section 27, is again shown as a solid line. For the beam axes 30′ forming in the event of a misalignment, the condition again applies that they are perpendicular to the optical surface of the first end mirror 24′. An intersection point 31 of the beam axes 30, 30′ is therefore provided at the focus of the optical element 40 and the laser medium 23 or its pump region is arranged there. The laser medium 23 could again be spaced apart from the intersection point 31, wherein the distance is less than the Rayleigh length.

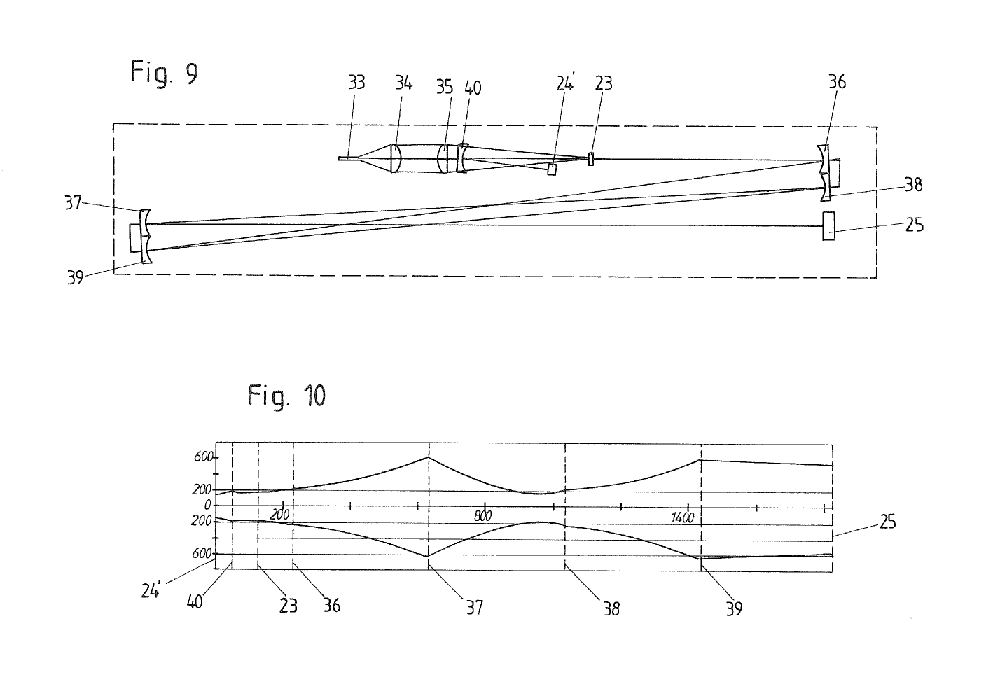

A concrete exemplary embodiment for the fundamental embodiment shown in FIG. 8 is shown in FIGS. 9 and 10. These are analogous illustrations to FIGS. 4 and 5.

At a distance (40 mm, for example) from the planar first end mirror 24′, the optical element 40 formed by a concave mirror having a radius of curvature of 150 mm is located. At a distance of 75 mm therefrom, i.e., half of the radius of curvature, the laser medium 23 is located. This corresponds to that of the first exemplary embodiment. The pumping can be performed through the optical element 40 in the above-described manner, wherein this optical element 40 is designed as a dichroic mirror. The folding mirror 36, which has a radius of curvature of 400 mm, is located at a distance of 100 mm from the laser medium. The folding mirrors 37-39 and the second end mirror 25 and their distances to one another or to the folding mirror 36 are identical as described in the first exemplary embodiment.

The mode radius in the laser medium is 183 μm here.

A folding mirror could be arranged between the first end mirror 24′ and the optical element 40 and/or between the optical element 40 and the laser medium 4.

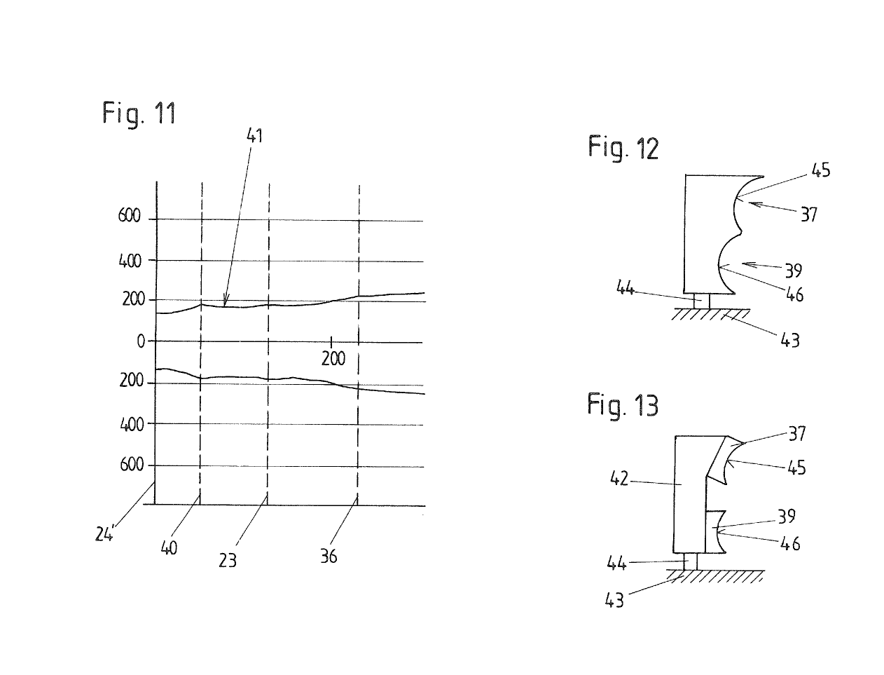

FIG. 11 shows an enlarged illustration of a detail of FIG. 10. It is particularly clearly obvious therefrom that the laser beam extends between the laser medium 23 and the adjacent focusing optical element 40 of the first resonator section 26 without diverging excessively strongly. The beam radius or mode radius also remains in the range of twice the value of the beam radius of the location of the laser medium 23 in this exemplary embodiment. It is also obvious from FIG. 11 that in the case of a design according to the invention, the beam waist (=constriction) 41 (which is formed by the focusing optical element) is not necessarily located at the location of the laser medium 23.

In addition to the embodiments shown in FIG. 3 and FIG. 8, further fundamental embodiments are also possible, wherein more than one focusing element could also be provided in the first resonator section 26 (wherein more than one intersection point of the beam axes 30, 30′ can result). The laser medium 4, if the resonator has multiple intersection points 31, is preferably arranged in the intersection point (or the pump region of the laser medium 23) located closest to one of the end mirrors (which is designated in the illustrated exemplary embodiments as the first end mirror).

FIGS. 12 and 13 show two exemplary embodiments of coupled optical elements as examples. E.g., these can be the folding mirrors 37, 39 or 36, 38 in the exemplary embodiments shown. The two optical elements are integrally designed with one another in the exemplary embodiment of FIG. 12. In the exemplary embodiment of FIG. 13, the optical elements 37, 39 are rigidly connected to one another, specifically via a shared base body 42 here, on which they are rigidly fastened. In both cases, the optical elements are jointly installed on a carrier part 43 of the resonator, preferably so they can be aligned. An installation part 44 for the installation on the carrier part 43 is only schematically indicated in FIGS. 12 and 13.

The coupled optical elements, for example, the folding mirrors 37, 39, have optical surfaces 45, 46 which have different centers of curvature. In other exemplary embodiments, different radii of curvature or different radii of curvature in combination with different centers of curvature could be provided. In still other exemplary embodiments, the optical surfaces of the coupled optical elements could be planar and lie in planes which are at an angle to one another, preferably enclose an angle of greater than 3° with one another. For example, an exemplary embodiment of such optical elements integrally designed with one another could appear like the base body 42 of FIG. 13 (without the optical elements 37, 39 attached thereto).

In further exemplary embodiments, one of the coupled optical elements, these are the folding mirrors 37, 39, for example, could have a curved optical surface and one could have a planar optical surface.

A tilt in the same direction of the optical elements 37, 39 or 36, 38, respectively, around parallel tilt axes results in opposing effects, for example, on the angle change of the output beam (at least the signs are opposite, the amounts could also be different). A mutual tilt of the optical elements 37, 39 or 36, 38, respectively, around an axis lying in the region of these optical elements, or their base body 42 or their installation part 44, therefore results in at least partial compensation of the effects connected thereto.

In addition to the above-mentioned operating modes of the laser resonator, such as mode-coupled resonator, Q-switched laser operation, and operation as a regenerative amplifier, operation as a mode-coupled and cavity-dumped resonator could also be provided to achieve higher energies, for example.

### LIST OF REFERENCE NUMERALS

1 first end mirror

2 second end mirror

3 output beam

4 laser medium

5 folding mirror

6 folding mirror

7 laser diode

8 optical element

9 optical element

10 optical element

11 folding mirror

12 prism

13 prism

14 aperture

15 laser medium

16 first end mirror

17 second end mirror

18 folding mirror

19 folding mirror

20 folding mirror

21 folding mirror

22 folding mirror

23 laser medium

24, 24′first end mirror

25 second end mirror

26 first resonator section

27 second resonator section

28 ABCD matrix

29 output beam

30, 30′beam axis

31 intersection point

32 folding mirror

33 laser diode

34 lens

35 lens

36 folding mirror

37 folding mirror

38 folding mirror

39 folding mirror

40 focusing optical element

41 beam waist

42 base body

43 carrier part

44 installation part

45 optical surface

46 optical surface

1. A laser comprising a laser medium, which is excited in a pump region, and a standing wave resonator, which includes optical elements, by which a laser beam, which has a beam axis and penetrates the laser medium, is guided and which comprise a first end mirror and a second end mirror, wherein the resonator comprises a first resonator section, which has at least the first end mirror, and a second resonator section, which has at least the second end mirror, wherein at least one of the optical elements of the first resonator section is a focusing optical element, by which the beam axes of the laser beam, which result upon respective tilts of at least one of the optical elements arranged in the second resonator section, have at least one intersection point, and wherein said intersection point or one of said intersection points of the beam axes of the laser beam lies in the pump region of the laser medium or has a distance from the pump region which is less than a Rayleigh length, which corresponds to a section of the laser beam which lies between the laser medium and a closest one of the focusing optical elements of the first resonator section, a radius (w) of the laser beam, at least over a section of the laser beam which lies between the laser medium and the closest focusing element of the first resonator section, is less than five times a radius (w) of the laser beam in the pump region of the laser medium.

2. The laser as claimed in claim 1, wherein the radius (w) of the laser beam in the entire first resonator section, is less than five times the radius (w) of the laser beam in the pump region of the laser medium.

3. The laser as claimed in claim 1, wherein only one of the optical elements of the first resonator section is the focusing optical element.

4. The laser as claimed in claim 1, wherein a focal length of the focusing optical element of the first resonator section closest to the laser medium is less than 100 mm.

5. The laser as claimed in claim 4, wherein the focal length of the focusing optical element of the first resonator section closest to the laser medium is less than 20 mm.

6. The laser as claimed in claim 1, wherein the first end mirror is a concave mirror.

7. The laser as claimed in claim 1, wherein the first end mirror is a planar mirror.

8. The laser as claimed in claim 1, wherein the focusing optical element of the first resonator section closest to the laser medium is a concave mirror.

9. The laser as claimed in claim 1, wherein the resonator is folded by one or more folding mirrors.

10. The laser as claimed in claims, claim 1, wherein the laser is a pulsed laser.

11. The laser as claimed in claim 1, wherein the radius (w) of the laser beam in the pump region of the laser medium is less than 250 μm.

12. The laser as claimed in claim 1, wherein at least two of the optical elements of the resonator, which are arranged at different distances from the first end mirror with respect to an unfolded resonator, are integrally designed with one another or rigidly connected to one another and are jointly installed on a carrier part of the resonator.

13. The laser as claimed in claim 12, wherein the at least two optical elements, which are integrally designed with one another or rigidly connected and are jointly installed on the carrier part, have optical surfaces, which are curved and have at least one of different centers of curvature or radii of curvature or which are flat and lie in planes at an angle to one another, or of the at least two optical elements which are integrally designed or rigidly connected and are jointly installed on the carrier part, at least one has a curved optical surface and at least one has a flat optical surface.

14. The laser as claimed in claim 12, wherein the at least two optical elements which are integrally designed or rigidly connected and are jointly installed on the carrier part are two folding mirrors, wherein the laser beam is deflected by at least one further folding mirror between the deflections on the two folding mirrors.

15. The laser as claimed in claim 12, wherein the at least two optical elements, which are integrally designed with one another or rigidly connected to one another and are jointly installed on the carrier part, upon a tilt in a same direction, have opposing effects on at least one of a displacement or an angle change of the beam axis of the laser beam in another of the optical elements of the resonator or in the laser medium.

16. The laser as claimed in claim 15, wherein the at least two optical elements, which are integrally designed with one another or rigidly connected to one another and are jointly installed on the carrier part, upon a tilt in the same direction, have opposing effects on at least one of the displacement or the angle change of the beam axis of the laser beam in an optical element of the resonator acting as the decoupler for the output beam.

17. The laser as claimed in claim 1, wherein the laser is a solid-state laser.

18. The laser as claimed in claim 1, wherein a distance of the pump region of the laser medium from the closest focusing optical element of the first resonator section is less than three times the value of the Rayleigh length, which corresponds to the section of the laser beam which lies between the laser medium and the closest focusing optical element of the first resonator section.

19. The laser as claimed in claim 1, wherein the resonator is designed as folded and has at least one folding mirror, which deflects the laser beam, for this purpose, and an unfolded length of the resonator is greater than 1 m.

20. The laser as claimed in claim 1, wherein a length of the first resonator section is less than one-fifth of a length of the second resonator section, and an unfolded length is used in the case of a folded design of the resonator by at least one folding mirror.

21. The laser as claimed in claim 1, wherein the first resonator section includes further optical elements, which interact with the laser beam between the first end mirror and the laser medium.

22. The laser as claimed in claim 1, wherein the second resonator section includes additional optical elements, which interact with the laser beam between the laser medium and the second end mirror.

23. The laser as claimed in claim 10, wherein the laser is a mode-coupled laser.
